(19) United States
(12) Patent Application Publication
(10) Pub. No.: US 2005/0181948 A1
(43) Pub. Date: Aug. 18, 2005

(54) Phenethylacrylamide, methods for the production thereof and agents containing the same

(76) Inventors: Wassilios Grammenos, Ludwigshafen (DE); Thomas Grote, Wachenheim (DE); Carsten Blettner, Mannheim (DE); Markus Gewehr, Kastellaun (DE); Andreas Gypser, Mannheim (DE); Bernd Muller, Frankenthal (DE); Joachim Rheinheimer, Ludwigshafen (DE); Peter Schafer, Ottersheim (DE); Anja Schwogler, Mannheim (DE); Jordi Tormo i Blasco, Laudenbach (DE); Norbert Gotz, Worms (DE); Gisela Lorenz, Neustadt (DE); Eberhard Ammermann, Heppenheim (DE); Siegfried Strathmann, Limburgerhof (DE); Reinhard Stierl, Mutterstadt (DE)

Correspondence Address: NOVAK DRUCE DELUCA & QUIGG, LLP, 1300 EYE STREET NW, SUITE 400 EAST, WASHINGTON, DC, 20005, US

(21) Appl. No.: 10/509,112

(22) PCT Filed: Mar. 27, 2003
(86) PCT No.: PCT/EP03/03212

(30) Foreign Application Priority Data
Mar. 28, 2002 (DE) 102 14 177.0

(51) Int. Cl. A01N 43/60; A01N 43/54; A01N 43/40

(52) U.S. Cl. 504/239; 504/235; 504/260; 544/335; 544/336; 546/336

(57) ABSTRACT

The present invention relates to novel phenethylacrylamides of the formula I 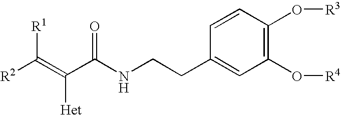
in which the substituents R¹, R², R³ and R⁴ have the following meanings:
R¹ is hydrogen, halogen, C₁-C₄-alkyl, C₁-C₄-alkoxy, C₃-C₈-cycloalkyl, C₁-C₄-haloalkoxy or C₁-C₄-haloalkyl;
R² is hydrogen, halogen, C₁-C₄-alkyl, C₁-C₄-alkoxy, C₃-C₁₀-cycloalkyl, C₁-C₄-haloalkoxy or C₁-C₄-haloalkyl;
R³ is C₁-C₄-alkyl, C₁-C₄-haloalkyl, propargyl, C₃-C₄-alkenyl or a radical of the formula —H₂C—C≡C—C(R^{a}, R^{a})—R^{c}, wherein R^{a}, R^{b} independently of one another are hydrogen or methyl and R^{c} is hydrogen or C₁-C₄-alkyl;
R⁴ is methyl or C₁-haloalkyl; and Het is a 5- or 6-membered heteroaromatic ring, to processes for their preparation, and to the use of phenethylacrylamides of the formula I for controlling phytopathogenic harmful fungi.

The present invention relates to novel phenethylacrylamides, processes for their preparation, and to the use of phenethylacrylamides for controlling phytopathogenic harmful fungi. Moreover, the invention relates to compositions for controlling phytopathogenic harmful fungi which comprise at least one phenethylacrylamide according to the invention.

WO-A 96/17825 and WO-A 96/23763 disclose, inter alia, fungicidally active phenethylamides of α-oximinophenylacetic acid.

WO 01/95721 describes phenethylacrylamides of the formula 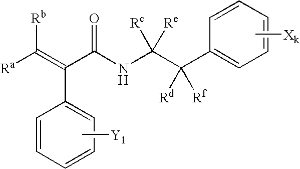
in which the substituents have the following meanings:
X is halogen, C₁-C₄-alkyl, C₁-C₄-haloalkyl, C₁-C₈-alkoxy, C₁-C₄-haloalkoxy and —O—C(R^{g},R^{h})—C≡C—Rⁱ, wherein R^{g},R^{h} independently of one another are hydrogen and C₁-C₆-alkyl and Rⁱ is hydrogen, C₁-C₈-alkyl, C₃-C₈-cycloalkyl and phenyl which can be substituted by halogen, cyano, nitro, CF₃, C₁-C₄-alkyl and/or C₁-C₄-alkoxy;
Y is halogen, nitro, cyano, C₁-C₄-alkyl, CF₃, C₁-C₄-alkoxy and phenyl;
k,l independently of one another are 1 to 4, it being possible for the radicals X and Y to be different if k or l is greater than 1;
R^{a}, R^{b} independently of one another are hydrogen, halogen, C₁-C₄-alkyl, C₁-C₄-alkoxy, C₁-C₄-haloalkoxy and CF₃;
R^{c}, R^{d}, R^{e}, R^{f} independently of one another are hydrogen, C₁-C₄-alkyl and C₁-C₄-alkoxy or R^{c} and R^{d} jointly form a cyclopropyl ring, it being possible for the C—R^{e} and the C—R^{f} bonds to be in the E or Z position relative to one another;
and their use for controlling phytopathogenic harmful fungi.

However, the fungicidal action of the compounds described in the documents mentioned above is frequently not satisfactory.

It is an object of the invention to find compounds with an improved fungicidal action.

We have found that this object is achieved, surprisingly, by phenethylacrylamides of the formula I hereinbelow, which have a heterocyclic substituent in the a position relative to the carbonyl group of the acrylamide unit. The present invention relates to phenethylacrylamides of the formula I 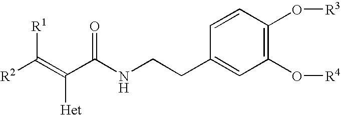
in which the substituents R¹, R², R³ and R⁴ have the following meanings:
R¹ is hydrogen, halogen, C₁-C₄-alkyl, C₁-C₄-alkoxy, C₃-C₁₀-cycloalkyl, C₁-C₄-haloalkoxy or C₁-C₄-haloalkyl;
R² is hydrogen, halogen, C₁-C₄-alkyl, C₁-C₄-alkoxy, C₃-C₁₀-cycloalkyl, C₁-C₄-haloalkoxy or C₁-C₄-haloalkyl;
R³ is C₁-C₄-alkyl, C₁-C₄-haloalkyl, propargyl, C₃-C₄-alkenyl or a radical of the formula —H₂C—C≡C—C(R^{a}, R^{b})—R^{c}, where R^{a}, R^{b} independently of one another are hydrogen or methyl and R^{c} is hydrogen or C₁-C₄-alkyl;
R⁴ is methyl or C₁-haloalkyl; and
Het is a 5- or 6-membered heteroaromatic ring which may contain a fused 5- or 6-membered carbocycle and which is selected from among heteroaromatic rings containing 1, 2, 3 or 4 nitrogen atoms as ring members, heteroaromatic rings which contain 1 or 2 nitrogen atoms and 1 or 2 further heteroatoms selected from among oxygen or sulfur as ring members, and heteroaromatic rings which have 1 or 2 heteroatoms selected from among oxygen and sulfur as ring members, Het being unsubstituted or it being possible for Het to contain 1, 2 or 3 substituents S selected from among halogen, C₁-C₄-alkyl, C₁-C₄-haloalkoxy, C₁-C₄-haloalkyl and C₁-C₄-alkoxy.

The invention also relates to the use of the phenethylacrylamides of the formula I as fungicides, and to the crop protection compositions comprising them.

Collective terms which generally represent the following substituents were used in the definitions of the symbols given in the formulae of the present application:
halogen: fluorine, chlorine, bromine and iodine;
C₁-C₄-alkyl: saturated, straight-chain or branched hydrocarbon radicals having 1 to 4 carbon atoms, for example methyl, ethyl, propyl, 1-methylethyl, butyl, 1-methylpropyl, 2-methylpropyl, 1,1-dimethylethyl;
C₃-C₁₀-cycloalkyl: a 3- to 10-membered, in particular 3- to 6-membered, cyclocaliphatic radical having 3 to 10, preferably 3 to 6, carbon atoms such as cyclopropyl, cyclobutyl, cyclopentyl, cyclohexyl, cycloheptyl and cyclooctyl, which radical can also have attached to it 1, 2, 3 or 4 methyl groups, like in methylcyclohexyl;
C₁-C₄-haloalkyl: straight-chain or branched alkyl groups having 1 to 4 carbon atoms (as mentioned above), it being possible for some or all of the hydrogen atoms in these groups to be replaced by halogen atoms as mentioned above, for example C₁-C₂-haloalkyl such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl and pentafluoroethyl;
C₁-C₄-alkoxy: straight-chain or branched alkyl groups having 1 to 4 carbon atoms (as mentioned above) which are bonded to the skeleton via an oxygen atom (—O—);
C₁-C₄-haloalkoxy: straight-chain or branched haloalkyl groups having 1 to 4 carbon atoms (as mentioned above) which are bonded to the skeleton via an oxygen atom (—O—);
C₃-C₄-alkenyl: alkenyl having 3 or 4 carbon atoms which is preferably not bonded to an olefinic carbon atom, such as allyl, methallyl and 2-buten-1-yl.
A 5- or 6-membered heteroaromatic ring is understood as meaning an aromatic 5- or 6-membered ring which contains, as ring members, one, two, three or four nitrogen atoms, 1 or 2 nitrogen atoms and one or two further heteroatoms selected from among oxygen and sulfur, or 1 or 2 heteroatoms selected from among oxygen and sulfur, that is to say
aromatic 5-membered rings such as:
   2-furyl, 3-furyl, 2-thienyl, 3-thienyl, pyrrol-2-yl, pyrrol-1-yl, pyrrol-3-yl, pyrazol-1-yl, pyrazol-3-yl, pyrazol-4-yl, isoxazol-3-yl, isoxazol-4-yl, isoxazol-5-yl, isothiazol-3-yl, isothiazol-4-yl, isothiazol-5-yl, imidazol-1-yl, imidazol-2-yl, imidazol-4-yl, oxazol-2-yl, oxazol-4-yl, oxazol-5-yl, thiazol-2-yl, thiazol-4-yl, thiazol-5-yl, 1,2,3-oxadiazol-4-yl, 1,2,3-oxadiazol-5-yl, 1,2,4-oxadiazol-3-yl, 1,2,4-oxadiazol-5-yl, 1,3,4-oxadiazol-2-yl, 1,2,3-thiadiazol-4-yl, 1,2,3-thiadiazol-5-yl, 1,2,4-thiadiazol-3-yl, 1,2,4-thiadiazol-5-yl, 1,3,4-thiadiazol-2-yl, 1,2,3-triazol-4-yl, 1,2,4-triazol-3-yl, tetrazol-5-yl, 1,2,3-triazol-1-yl, 1,2,4-triazol-1-yl, tetrazol-1-yl;
aromatic 6-membered rings such as:
   pyridin-2-yl, pyridin-3-yl, pyridin-4-yl, pyridazin-3-yl, pyridazin-4-yl, pyrimidin-2-yl, pyrimidin-4-yl, pyrimidin-5-yl, pyrazin-2-yl, 1,3,5-triazin-2-yl, 1,2,4-triazin-3-yl, 1,2,4-triazin-5-yl, 1,2,4-triazin-6-yl or 1,2,4,5-tetrazin-3-yl;
   it also being possible for Het to be a bicyclic ring system which the abovementioned heterocycles can form together with a fused 5- or 6-membered carbocycle, for example with a phenyl ring or with a mono- or diunsaturated C₅-C₆-carbocycle.

Het with a fused carbocycle is, for example, benzofuranyl, benzothienyl, indolyl, benzoxazolyl, benzothiazolyl, benzimidiazolyl, quinolinyl, isoquinolinyl, quinazolinyl, quinoxalinyl, 5,6,7,8-tetrahydroisoquinoline or the like.

With a view to the fungicidal action of the phenethylacrylamides of the formula I, preferred compounds I are those in which R¹ and R² are different and R¹ is a radical with a volume greater than that of R², i.e. R¹ has a greater van-der-Waals radius than R² . Preferred among these are phenethylacrylamides I in which R² is hydrogen and R¹ is a radical other than hydrogen, preferably C₁-C₄-alkyl or C₃-C₅-cycloalkyl, in particular ethyl, isopropyl, tert-butyl or cyclopropyl.

Preferred compounds I are furthermore those in which R¹ and R² are identical and are chlorine, fluorine or methyl.

Preferably, Het has at least one, in particular 1 or 2, substituents S. Preferred substituents on Het are: methyl, ethyl, isopropyl, methoxy, trifluoromethyl, difluoromethyl, fluorine, chlorine, bromine and difluoromethoxy, in particular methyl, chlorine, bromine and CF₃. S is preferably not bonded in the ortho position relative to the linkage site.

Het is preferably C-bonded and is, in particular, an aromatic heterocycle which can be substituted in the above-described manner and which has, in particular, 1 or 2 substituents S, specifically those substituents S which have been indicated as being preferred.

Het is, in particular, selected from among preferably mono- or disubstituted:
aromatic 6-membered C-bonded heterocycles with 1 or 2 nitrogen atoms such as pyridyl, pyrimidinyl or pyrazinyl, in particular 2-, 3- or 4-pyridyl, 4- or 5-pyrimidinyl and 2-pyrazinyl;
5-membered aromatic C-bonded heterocycles with one nitrogen atom and one further heteroatom selected from among O, S and N, such as pyrazolyl, imidazolyl, oxazolyl, isoxazolyl, thiazolyl and isothiazolyl, in particular 2-oxazolyl, 2- or 3-pyrazolyl; and
5-membered aromatic C-bonded heterocycles with one heteroatom selected from among O, S and N, such as pyrrolyl, furanyl or thienyl, in particular 3-furanyl or 3-thienyl.

Preferred with regard to the fungicidal action of the phenethylacrylamides of the formula I are, moreover, the following meanings of the substituens R¹, R², R³ and R⁴, in each case alone or, in particular, in combination and, specifically, in combination with the meanings for Het and S which have been stated above as being preferred:
R¹ fluorine, chlorine, C₁-C₄-alkyl, C₁-C₄-alkoxy, C₃-C₆-cycloalkyl and CF₃, in particular C₁-C₄-alkyl or C₃-C₆-cycloalkyl, and specifically isopropyl, tert-butyl or cyclopropyl;
R² hydrogen, fluorine, chlorine or methyl, in particular hydrogen;
R³ methyl, ethyl, CF₃, CH₂CF₃, allyl, propargyl or CH₂—C≡C—CH₂—(C₁-C₄-alkyl), in particular methyl, ethyl or propargyl;
R⁴ methyl or CHF₂.

Especially preferred embodiments of the invention are the phenethylacrylamides of the formulae I.1 to I.3: 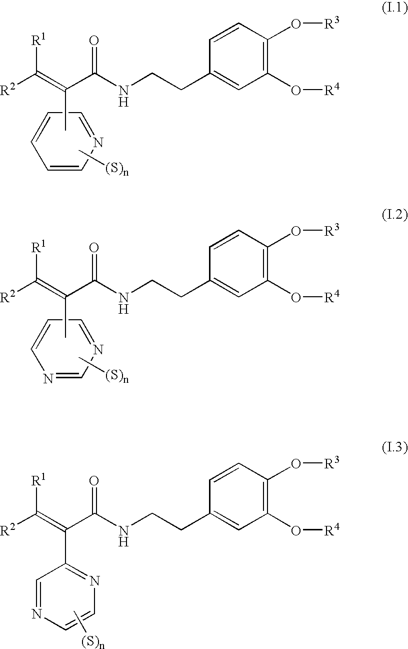
in which the substituents S, R¹, R², R³ and R⁴ have the abovementioned meanings, in particular the meanings which have been mentioned above as being preferred, n is 1 or 2 and S is not bonded in the ortho position relative to the linkage site (i.e. in the 3 and/or 4 position relative to the linkage site).

Likewise preferred are the compounds of the general formula I wherein Het is one of the radicals Het-4 to Het-8 given hereinbelow. Accordingly, these compounds are hereinbelow also referred to as compounds I.4 to I.8.

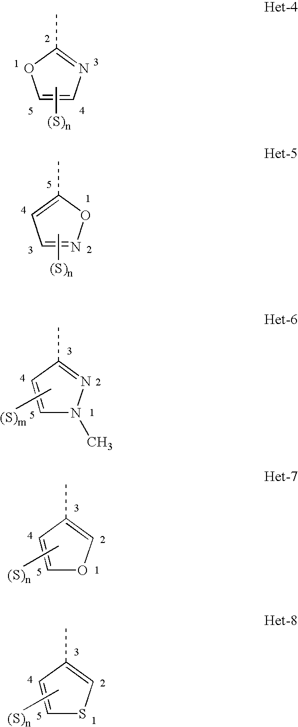

In the formulae Het-4 to Het-8, S has the abovementioned meaning. The variable n is 0, 1 or 2, preferably 1, and the variable m is 0 or 1.

Especially preferred with regard to their use are the compounds I compiled in the Tables 1 to 31 which follow. Moreover, the groups mentioned in the tables for Het and S constitute an especially preferred embodiment of the compounds according to the invention, independently of the combination with the substituents R¹ to R⁴ in which they are mentioned.

Table 1

Compounds of the formula I.1 with a 2-pyridyl radical in which (S)ₙ is 4-trifluoromethyl and wherein, for a given compound, R¹, R², R³ and R⁴ correspond to one line of Table A (compounds I.1a.1 to I.1a.81).

Table 2

Compounds of the formula I.1 with a 2-pyridyl radical in which (S)ₙ is 4-CH₃ and wherein, for a given compound, R¹, R², R³ and R⁴ correspond to one line of Table A (compounds I.1b.1 to I.1b.81).

Table 3

Compounds of the formula I.1 with a 2-pyridyl radical in which (S)n is 4-OCH₃ and wherein, for a given compound, R¹, R², R³ and R⁴ correspond to one line of Table A (compounds I.1c.1 to I.1c.81).

Table 4

Compounds of the formula I.1 with a 2-pyridyl radical in which (S)n is 4-Cl and wherein, for a given compound, R¹, R², R³ and R⁴ correspond to one line of Table A (compounds I.1d.1 to I.1d.81).

Table 5

Compounds of the formula I.1 with a 2-pyridyl radical in which (S)ₙ is 4-Br and wherein, for a given compound, R¹, R², R³ and R⁴ correspond to one line of Table A (compounds I.1e.1 to I.1e.81).

Table 6

Compounds of the formula I.1 with a 3-pyridyl radical in which (S)ₙ is 4-trifluoromethyl and wherein, for a given compound, R¹, R², R³ and R⁴ correspond to one line of Table A (compounds I.1f.1 to I.1f.81).

Table 7

Compounds of the formula I.1 with a 3-pyridyl radical in which (S)ₙ is 4-CH₃ and wherein, for a given compound, R¹, R², R³ and R⁴ correspond to one line of Table A (compounds I.1g.1 to I.1g.81).

Table 8

Compounds of the formula I.1 with a 3-pyridyl radical in which (S)ₙ is 4-OCH₃ and wherein, for a given compound, R¹, R², R³ and R⁴ correspond to one line of Table A (compounds I.1h.1 to I.1h.81).

Table 9

Compounds of the formula I.1 with a 2-pyridyl radical in which (S)ₙ is 5-trifluoromethyl and wherein, for a given compound, R¹, R², R³ and R⁴ correspond to one line of Table A (compounds I.1i.1 to I.1i.81).

Table 10

Compounds of the formula I.1 with a 2-pyridyl radical in which (S)ₙ is 5-Cl and wherein, for a given compound, R¹, R², R³ and R⁴ correspond to one line of Table A (compounds I.1k.1 to I.1k.81).

Table 11

Compounds of the formula I.1 with a 2-pyridyl radical in which (S)ₙ is 5-Br and wherein, for a given compound, R¹, R², R³ and R⁴ correspond to one line of Table A (compounds I.1m.1 to I.1m.81).

Table 12

Compounds of the formula I.1 with a 2-pyridyl radical in which (S)ₙ is 5-OCH₃ and wherein, for a given compound, R¹, R², R³ and R⁴ correspond to one line of Table A (compounds I.1n.1 to I.1n.81).

Table 13

Compounds of the formula I.2 with a 4-pyrimidinyl radical in which (S)ₙ is 6-trifluoromethyl and wherein, for a given compound, R¹, R², R³ and R⁴ correspond to one line of Table A (compounds I.2a.1 to I.2a.81).

Table 14

Compounds of the formula I.2 with a 4-pyrimidinyl radical in which (S)ₙ is 6-CH₃ and wherein, for a given compound, R¹, R², R³ and R⁴ correspond to one line of Table A (compounds I.2b.1 to I.2b.81).

Table 15

Compounds of the formula I.2 with a 4-pyrimidinyl radical in which (S)ₙ is 6-OCH₃ and wherein, for a given compound, R¹, R², R³ and R⁴ correspond to one line of Table A (compounds I.2c.1 to I.2c.81).

Table 16

Compounds of the formula I.2 with a 4-pyrimidinyl radical in which (S)ₙ is 2-trifluoromethyl and wherein, for a given compound, R¹, R², R³ and R⁴ correspond to one line of Table A (compounds I.2d.1 to I.2d.81).

Table 17

Compounds of the formula I.2 with a 4-pyrimidinyl radical in which (S)ₙ is 2-CH₃ and wherein, for a given compound, R¹, R², R³ and R⁴ correspond to one line of Table A (compounds I.2e.1 to I.2e.81).

Table 18

Compounds of the formula I.2 with a 4-pyrimidinyl radical in which (S)ₙ is 2-OCH₃ and wherein, for a given compound, R¹, R², R³ and R⁴ correspond to one line of Table A (compounds I.2f.1 to I.2f.81).

Table 19

Compounds of the formula I.2 with a 5-pyrimidinyl radical in which (S)ₙ is 2-trifluoromethyl and wherein, for a given compound, R¹, R², R³ and R⁴ correspond to one line of Table A (compounds I.2g.1 to I.2g.81).

Table 20

Compounds of the formula I.2 with a 5-pyrimidinyl radical in which (S)ₙ is 2-CH₃ and wherein, for a given compound, R¹, R², R³ and R⁴ correspond to one line of Table A (compounds I.2h.1 to I.2h.81).

Table 21

Compounds of the formula I.2 with a 5-pyrimidinyl radical in which (S)ₙ is 2-OCH₃ and wherein, for a given compound, R¹, R², R³ and R⁴ correspond to one line of Table A (compounds I.2i.1 to I.2i.81).

Table 22

Compounds of the formula I.3 with a 2-pyrazinyl radical in which (S)ₙ is 5-trifluoromethyl and wherein, for a given compound, R¹, R², R³ and R⁴ correspond to one line of Table A (compounds I.3a.1 to I.3a.81).

Table 23

Compounds of the formula I.3 with a 2-pyrazinyl radical in which (S)ₙ is CH₃ and wherein, for a given compound, R¹, R², R³ and R⁴ correspond to one line of Table A (compounds I.3b.1 to I.3b.81).

Table 24

Compounds of the formula I.3 with a 2-pyrazinyl radical in which (S)ₙ is OCH₃ and wherein, for a given compound, R¹, R², R³ and R⁴ correspond to one line of Table A (compounds I.3c.1 to I.3c.81).

Table 25

Compounds of the formula I.4, wherein Het is a radical Het-4 and (S)ₙ is hydrogen (n=0) and wherein, for a given compound, R¹, R², R³ and R⁴ correspond to one line of Table A (compounds I.4a.1 to I.4a.81).

Table 26

Compounds of the formula I.5, wherein Het is a radical Het-5 and (S)ₙ is hydrogen (n=0) and wherein, for a given compound, R¹, R², R³ and R⁴ correspond to one line of Table A (compounds I.5a.1 to I.5a.81).

Table 27

Compounds of the formula I.6, wherein Het is a radical Het-6 and (S)m is hydrogen (m=0) and wherein, for a given compound, R¹, R², R³ and R⁴ correspond to one line of Table A (compounds I.6a.1 to I.6a.81).

Table 28

Compounds of the formula I.7, wherein Het is a radical Het-7 and (S)ₙ is hydrogen (n=0) and wherein, for a given compound, R¹, R², R³ and R⁴ correspond to one line of Table A (compounds I.7a.1 to I.7a.81).

Table 29

Compounds of the formula I.7 wherein Het=Het-7 in which (S)ₙ is 5-chloro and wherein, for a given compound, R¹, R², R³ and R⁴ correspond to one line of Table A (compounds I.7b.1 to I.7b.81).

Table 30

Compounds of the formula I.8 wherein Het=Het-8 in which (S)ₙ is hydrogen (n=0) and wherein, for a given compound, R¹, R², R³ and R⁴ correspond to one line of Table A (compounds I.8a.1 to I.8a.81).

Table 31

Compounds of the formula I.8 wherein Het=Het-8 in which (S)ₙ is 5-chloro and wherein, for a given compound, R¹, R², R³ and R⁴ correspond to one line of Table A (compounds I.8b.1 to I.8b.81).

TABLE A

| No. | R¹ | R² | R³ | R⁴ |
|---|---|---|---|---|
| 1 | CH₃ | H | CH₃ | CH₃ |
| 2 | C₂H₅ | H | CH₃ | CH₃ |
| 3 | C(CH₃)₃ | H | CH₃ | CH₃ |
| 4 | CH(CH₃)₂ | H | CH₃ | CH₃ |
| 5 | c-C₃H₅ | H | CH₃ | CH₃ |
| 6 | c-C₅H₉ | H | CH₃ | CH₃ |
| 7 | CH₃ | CH₃ | CH₃ | CH₃ |
| 8 | F | F | CH₃ | CH₃ |
| 9 | Cl | Cl | CH₃ | CH₃ |
| 10 | CH₃ | H | C₂H₅ | CH₃ |
| 11 | C₂H₅ | H | C₂H₅ | CH₃ |
| 12 | C(CH₃)₃ | H | C₂H₅ | CH₃ |
| 13 | CH(CH₃)₂ | H | C₂H₅ | CH₃ |
| 14 | c-C₃H₅ | H | C₂H₅ | CH₃ |
| 15 | c-C₅H₉ | H | C₂H₅ | CH₃ |
| 16 | CH₃ | CH₃ | C₂H₅ | CH₃ |
| 17 | F | F | C₂H₅ | CH₃ |
| 18 | Cl | Cl | C₂H₅ | CH₃ |
| 19 | CH₃ | H | CH₂—CH═CH₂ | CH₃ |
| 20 | C₂H₅ | H | CH₂—CH═CH₂ | CH₃ |
| 21 | C(CH₃)₃ | H | CH₂—CH═CH₂ | CH₃ |
| 22 | CH(CH₃)₂ | H | CH₂—CH═CH₂ | CH₃ |
| 23 | c-C₃H₅ | H | CH₂—CH═CH₂ | CH₃ |
| 24 | c-C₅H₉ | H | CH₂—CH═CH₂ | CH₃ |
| 25 | CH₃ | CH₃ | CH₂—CH═CH₂ | CH₃ |
| 26 | F | F | CH₂—CH═CH₂ | CH₃ |
| 27 | Cl | Cl | CH₂—CH═CH₂ | CH₃ |
| 28 | CH₃ | H | CH₂—C≡CH₂ | CH₃ |
| 29 | C₂H₅ | H | CH₂—C≡CH₂ | CH₃ |
| 30 | C(CH₃)₃ | H | CH₂—C≡CH₂ | CH₃ |
| 31 | CH(CH₃)₂ | H | CH₂—C≡CH₂ | CH₃ |
| 32 | c-C₃H₅ | H | CH₂—C≡CH₂ | CH₃ |
| 33 | c-C₅H₉ | H | CH₂—C≡CH₂ | CH₃ |
| 34 | CH₃ | CH₃ | CH₂—C≡CH₂ | CH₃ |
| 35 | F | F | CH₂—C≡CH₂ | CH₃ |
| 36 | Cl | Cl | CH₂—C≡CH₂ | CH₃ |
| 37 | CH₃ | H | CH₃ | CHF₂ |
| 38 | C₂H₅ | H | CH₃ | CHF₂ |
| 39 | C(CH₃)₃ | H | CH₃ | CHF₂ |
| 40 | CH(CH₃)₂ | H | CH₃ | CHF₂ |
| 41 | c-C₃H₅ | H | CH₃ | CHF₂ |
| 42 | c-C₅H₉ | H | CH₃ | CHF₂ |
| 43 | CH₃ | CH₃ | CH₃ | CHF₂ |
| 44 | F | F | CH₃ | CHF₂ |
| 45 | Cl | Cl | CH₃ | CHF₂ |
| 46 | CH₃ | H | C₂H₅ | CHF₂ |
| 47 | C₂H₅ | H | C₂H₅ | CHF₂ |
| 48 | C(CH₃)₃ | H | C₂H₅ | CHF₂ |
| 49 | CH(CH₃)₂ | H | C₂H₅ | CHF₂ |
| 50 | c-C₃H₅ | H | C₂H₅ | CHF₂ |
| 51 | c-C₅H₉ | H | C₂H₅ | CHF₂ |
| 52 | CH₃ | CH₃ | C₂H₅ | CHF₂ |
| 53 | F | F | C₂H₅ | CHF₂ |
| 54 | Cl | Cl | C₂H₅ | CHF₂ |
| 55 | CH₃ | H | CH₂—CH═CH₂ | CHF₂ |
| 56 | C₂H₅ | H | CH₂—CH═CH₂ | CHF₂ |
| 57 | C(CH₃)₃ | H | CH₂—CH═CH₂ | CHF₃ |
| 58 | CH(CH₃)₂ | H | CH₂—CH═CH₂ | CHF₂ |
| 59 | c-C₃H₅ | H | CH₂—CH═CH₂ | CHF₂ |
| 60 | c-C₅H₉ | H | CH₂—CH═CH₂ | CHF₂ |
| 61 | CH₃ | CH₃ | CH₂—CH═CH₂ | CHF₂ |
| 62 | F | F | CH₂—CH═CH₂ | CHF₂ |
| 63 | Cl | Cl | CH₂—CH═CH₂ | CHF₂ |
| 64 | CH₃ | H | CH₂—C≡CH₂ | CHF₂ |
| 65 | C₂H₅ | H | CH₂—C≡CH₂ | CHF₂ |
| 66 | C(CH₃)₃ | H | CH₂—C≡CH₂ | CHF₂ |
| 67 | CH(CH₃)₂ | H | CH₂—C≡CH₂ | CHF₂ |
| 68 | c-C₃H₅ | H | CH₂—C≡CH₂ | CHF₂ |
| 69 | c-C₅H₉ | H | CH₂—C≡CH₂ | CHF₂ |
| 70 | CH₃ | CH₃ | CH₂—C≡CH₂ | CHF₂ |
| 71 | F | F | CH₂—C≡CH₂ | CHF₂ |
| 72 | Cl | Cl | CH₂—C≡CH₂ | CHF₂ |
| 73 | CH₃ | H | CH₂—CF₃ | CH₃ |
| 74 | C₂H₅ | H | CH₂—CF₃ | CH₃ |
| 75 | C(CH₃)₃ | H | CH₂—CF₃ | CH₃ |
| 76 | CH(CH₃)₂ | H | CH₂—CF₃ | CH₃ |
| 77 | c-C₃H₅ | H | CH₂—CF₃ | CH₃ |
| 78 | c-C₅H₉ | H | CH₂—CF₃ | CH₃ |
| 79 | CH₃ | CH₃ | CH₂—CF₃ | CH₃ |
| 80 | F | F | CH₂—CF₃ | CH₃ |
| 81 | Cl | Cl | CH₂—CF₃ | CH₃ |

In Table A, c- is cyclo.

In principle, phenethylacrylamides of the formula I can be prepared analogously to the prior-art methods mentioned at the outset for the preparation of phenethylamides and in accordance with the processes illustrated hereinbelow in greater detail.

Moreover, phenethylacrylamides of the formula I wherein R² is hydrogen and R¹ is hydrogen or a radical other than hydrogen, for example C₁-C₄-alkyl, C₃-C₈-cycloalkyl or C₁-C₄-haloalkyl, and Het, R³ and R⁴ have the abovementioned meanings, can be prepared in accordance with the following process:
a) reaction of a phenethylamide of the formula II 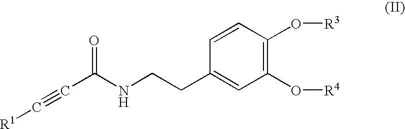
   in which the substituents R¹, R³ and R⁴ have the abovementioned meanings, with a trialkylstannane (R^{a})₃SnH, wherein R^{a} is alkyl having preferably 1 to 4 carbon atoms, resulting in a compound of the formula III 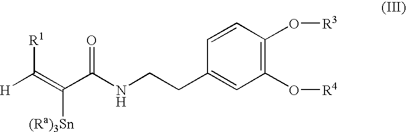
   wherein the substituents R^{a}, R¹, R³ and R⁴ have the abovementioned meanings, and
b) reaction of the compound III obtained in step a) with a compound Het-Hal, wherein Hal is bromine or iodine and Het is one of the above-defined, substituted or unsubstituted aromatic heterocycle, in the presence of catalytically active amounts of a transition metal compound of a group VIII metal, in particular of a palladium(0) and/or a palladium(II) compound.

Step a) is carried out in a manner known per se as described in Synthetic Communications 23(2), 143-152 (1993) and Tetrahedron 48(40), 8801-8824 (1992).

Step b) is carried out in a manner known per se under the conditions which are customary for a Stille coupling (re. Stille reaction, see: D. Milstein, J. K. Stille, J. Am. Chem. Soc. 1978, 100, pp.3636-3638; V. Farina et al. Org. R^{e} act. 1997, 50, 1-652; J. K. Stille, Angew. Chem. Int. Ed. Engl. 1986, 25, 508).

Preferred as catalysts are palladium(0) and/or palladium(II) compounds, in particular those which have at least one phosphine or nitrile ligand. Examples of phosphine ligands are triarylphosphines such as triphenylphosphine (=PPh₃) and tri(o-tolyl)phosphine (=P(o-tolyl)₃), but also trialkylphosphines and tricycloalkylphosphines such as tricyclohexylphosphine. Examples of nitrile ligands are, in particular, arylnitriles such as benzonitrile. Examples of especially preferred catalysts are palladium(0)tetrakis(triarylphosphine) such as Pd[PPh₃]₄, Pd[P(o-tolyl)₃]₄ or a dichloropalladium(II)bis(triarylphosphine) such as PdCl₂(PPh₃)₂. The amounts required for effective catalysis are usually in the range of from 0.5 to 10 mol %, preferably 1 to 5 mol %, based on the compound which is present in a substoichiometric amount, for example the organotin compound III. The addition of catalytically active amounts of Cu(I) salts such as Cu(I)I in amounts of from 0.5 to 10 mol %, preferably 1 to 5 mol %, based on the compound, for example the organotin compound III, which is present in a substoichiometric amount is advantageous.

The temperature required for the reaction in step b) is, as a rule, in the range of from 0 to 140° C., preferably in the range of from 20 to 80° C.

Usually, the compound III and Het-Hal will be employed in the stoichiometrically required amounts, Het-Hal frequently being used in an excess in order to improve the yield. In particular, the molar ratio of compound III to Het-Hal is in the range of from 1:0.95 to 1:1.2 and especially preferably in the range of from 1:0.99 to 1:1.1.

Step b) is usually carried out in an organic solvent, aprotic solvents generally being preferred. Particularly suitable are aprotic polar solvents such as dimethylformamide, dimethyl sulfoxide, N-methylpyrrolidone, tetrahydrofuran, dioxane and aromatic hydrocarbons such as toluene and mixtures of these solvents.

The heteroaryl halides Het-Hal which are employed in step b) are known or can be prepared by conventional methods (see JP 56115776, DE 2820032-A1, WO 95/31439-A1).

Similarly, phenethylacrylamides of the formula I where R²═H, wherein R¹ is hydrogen or a radical other than hydrogen, for example C₁-C₄-alkyl, C₃-C₈-cycloalkyl or C₁-C₄-haloalkyl, and Het, R³ and R⁴ have the abovementioned meanings are successfully prepared by the following method:
a′) reaction of a compound of the formula II with at least stoichiometric amounts of iodine, resulting in a compound of the formula IV 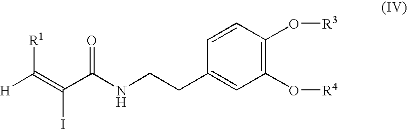
   wherein the substituents R¹, R³ and R⁴ have the abovementioned meanings, and
b′) reaction of the compound IV obtained in step a′) with a stannane of the formula (R^{a})₃Sn-Het, wherein Het has the meaning stated in claim 1, in the presence of catalytically active amounts of a transition metal compound of a group VIII metal, in particular a palladium(0) and/or a palladium(II) compound, for example a palladiumtetrakis(triarylphosphine) such as Pd[PPh₃]₄ or a dichloropalladium(II)bis(triarylphosphine) such as PdCl₂(PPh₃)₂.

The preparation of the compound IV from the compound II is carried out in a manner known per se by reacting II with elemental iodine as described in Synthetic Communications, 23(2), 143-152 (1993); Tetrahedron Letters 33 (31) 4495-98 (1992) and Tetrahedron 48 (40), 8801-8824 (1992).

Coupling of the iodine compound IV with the heterocyclic stannanes Het-Sn(R^{a})₃ is carried out in a manner known per se under the conditions of a Stille coupling, for example under the reaction conditions described for step b).

The heterocyclic stannanes are commercially available in some cases or can be prepared by customary methods of metallo-organic chemistry, for example by reacting Grignard compounds Het-Mg—X (X═Cl, Br or I) or organolithium compounds Het-Li with halotrialkylstannanes Hal-Sn(R^{a})₃ (Hal=Cl, Br): see, for example, Synlett (9), 916 (1996); J. Am. Chem. Soc. 106, 4833 (1984); Tetrahedron Letters 39(47), 8643-44 (1998); Synthesis (5), 779-82 (1999); and J. Chem. Soc. B, p. 465 (1968). The Grignard compounds and the lithium compounds, in turn, can be obtained in the known manner from the corresponding halogen-substituted heterocycle Het-Hal (see, for example, Tetrahedron 42(14), 3981-86 (1986); Tetrahedron Letters 31(32), 4625-26 (1990); DE-A 3823979; and M. Schlosser, Organometallics in Synthesis, Wiley-Verlag (1994), p. 55ff and references cited therein).

Analogously, steps a) and b), or a′) and b′), respectively, can be carried out starting from phenethylamides of the formula II″ 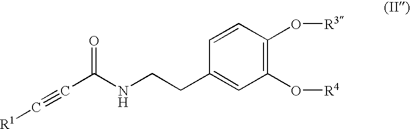
where, in formula II″, the substituents R¹ and R⁴ have the abovementioned meanings and R³″ is hydrogen or an OH protecting group. In this manner, the phenethylacrylamides of the formula I′ 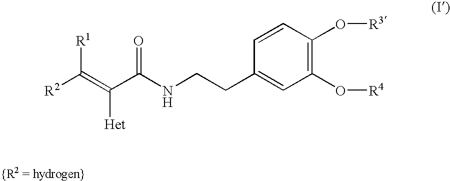
are obtained, in which R²═H, wherein R¹, Het and R⁴ have the abovementioned meanings and R³′ is hydrogen or an OH protecting group.

The compounds I′ can, if appropriate after removal of the protecting group, be reacted with a compound of the formula R³—Y, wherein R³ has the abovementioned meaning and Y is a nucleophilically displaceable leaving group. In this manner, the corresponding phenethylacrylamide of the formula I where R²=hydrogen is obtained.

Examples of nucleophilically displaceable leaving groups Y are halogen, in particular chlorine, bromine or iodine, tosylate, methylsulfonate, triflate, acetate and the like.

Examples of OH protecting groups are tetrahydropyran-2-yl, BOC, trialkylsilyl and alkoxyalkyl such as MOM and MEM. They are introduced and removed successfully by methods known from the literature (see, for example, B. P. J. Kocienski, Protecting Groups, Georg Thieme Verlag 2000, pp. 22-94).

The reaction of phenethylacrylamides of the formula I′ wherein R³′ is hydrogen with the compounds R³-Y is carried out in a manner known per se by processes known from the literature (see, for example, B. J. March, Advanced Organic Synthesis, 3rd ed. John Wiley pp. 342-343 and references cited therein, and WO 98/38160).

To this end, the compound I′ wherein R³′═H is reacted with preferably at least stoichiometric amounts of the compound R³—Y, or an excess, for example up to 10 mol, per mole of compound I′. The reaction is preferably carried out in an organic solvent, preferably in the presence of an auxiliary base. Examples of suitable auxiliary bases are alkali metal carbonates and alkali metal hydrogen carbonates, for example sodium carbonate, potassium carbonate, sodium hydrogen carbonate or potassium hydrogen carbonate, tertiary amine, for example triethylamine, pyridine, DBN or DBU, alkali metal alkoxides such as sodium methoxide, sodium ethoxide, sodium-tert-butoxide, the corresponding potassium alkoxides, and alkali metal hydrides such as sodium hydride. The auxiliary base is preferably employed in at least equimolar amounts based on the compound I′, in particular in an amount of from 1.1 to 10 mol per mole of compound I′. Solvents which are suitable are, in principle, all those which are suitable for nucleophilic substitution reactions (S_{N} reactions), for example highly polar aprotic solvents such as acetonitrile, dimethylformamide, dimethyl sulfoxide, N-methylpyrrolidone, tetramethylurea, aprotic polar solvents of medium polarity such as dioxane, tetrahydrofuran, halogenated hydrocarbons such as dichloromethane, dichloroethane, alcoholic solvents such as methanol, ethanol, n- and isopropanol, n-butanol, isobutanol, and furthermore water and mixtures of the above solvents. In some cases it may be advantageous to use phase transfer catalysts, for example crown ethers or quaternary ammonium salts. Preferred solvents are aprotic and highly polar (polar-aprotic). The temperatures required for the reaction are in the range of from −20 to +100° C., preferably in the range of from 10 to +80° C.

Analogously, the reaction with compounds R³—Y may also be used for the preparation of other phenethylacrylamides of the formula I in which R² is a radical other than hydrogen. The phenethylacrylamides of the formula I′, being important intermediates for the preparation of phenethylacrylamides I, are therefore likewise subject matter of the present invention.

The phenethylamides of the formula II which are employed as starting materials can be prepared in the manner known per se [cf. Houben-Weyl, Methoden der Organischen Chemie [Methods in organic chemistry], Vol. E5, p. 941-972, Georg Thieme Verlag Stuttgart and New York 1985; see also Tetrahedron 55(46), 13159-70 (1999)] by reacting phenethylamines of the formula VI with propiolic acid compounds of the formula V, if appropriate in the presence of suitable amidation catalysts, auxiliary bases and/or dehydrating agents, following the method shown in scheme 1:

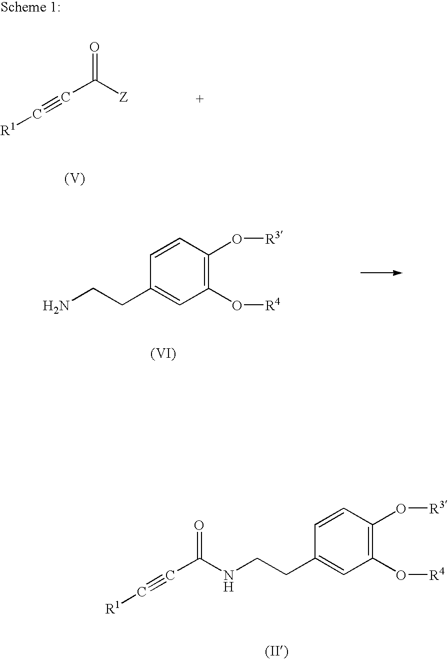

Propiolic acids of the formula V are either commercially available or can be prepared in the manner known per se (see Synthesis, p. 72 (1981), Synthesis 498-499 (1987)).

In scheme 1, R¹ and R⁴ have the abovementioned meanings. R³′ has the meanings mentioned for R³ and can also be an OH protecting group or hydrogen. Z is a nucleophilically displaceable leaving group, for example OH, halogen, in particular chlorine.

If Z is OH, the reaction is preferably carried out in the presence of dehydrating agents, for example in the presence of carbodiimides such as dicyclohexylcarbodiimide, or diimidazolylcarbonyl, for example analogously to the methods described in Houben-Weyl, Vol. E5, p. 941-972 (1985).

As an alternative, the carboxylic acids of the formula V{Z=OH} can, before the amidation, first be activated with VI, for example by conversion into acid halides, in particular into acid chlorides of the formula V{Z=Cl}, analogously to the conditions described in WO 01/95721.

Chlorinating agents which are suitable in this reaction are the customary inorganic and organic chlorinating agents, for example thionyl chloride, oxalyl chloride, alkyl chloroformate such as ethyl chloroformate and isobutyl chloroformate, phosphorus trichloride, phosphorus pentachloride, phosphorus oxychloride, triphenylphosphine/CCl₄, preferably thionyl chloride.

In general, the chlorinating agents are employed in at least equimolar amounts. It may be advantageous for the yield to employ them in an excess of up to 10 mol per mole of IV, preferably up to 5 mol, in particular up to 3 mol.

The chlorination of carboxylic acids V{X═OH} is usually carried out at temperatures in the range of from −20° C. to 100° C., preferably from −10° C. to 80° C., in an inert organic solvent [cf. organikum [organic chemistry], 16th Ed., p. 423 et seq., VEB Deutscher Verlag der Wissenschaften, Berlin 1985].

The chlorination is usually carried out in a solvent or diluent. Suitable solvents are aliphatic hydrocarbons such as pentane, hexane, cyclohexane and petroleum ether, aromatic hydrocarbons such as toluene, o-, m- and p-xylene, halogenated hydrocarbons such as methylene chloride, chloroform and chlorobenzene, ethers such as diethyl ether, diisopropyl ether, tert-butyl methyl ether, dioxane, anisole and tetrahydrofuran, nitriles such as acetonitrile and propionitrile, ketones such as acetone, methyl ethyl ketone, diethyl ketone and tert-butyl methyl ketone, and dimethyl sulfoxide, dimethylformamide and dimethylacetamide, especially preferably acetonitrile, toluene and tetrahydrofuran. Mixtures of the above may also be used. The liquid chlorinating agent may also act as the solvent.

This reaction is usually carried out at temperatures of from 0° C. 40 to 80° C., preferably 20° C. to 40° C., in an inert organic solvent in the presence of a base [cf. Organikum, 16th Ed., p. 412 et seq., VEB Deutscher Verlag der Wissenschaften, Berlin 1985].

The resulting acid chloride is subsequently reacted with the phenethylamine VI. As a rule, the reaction is carried out in a solvent or diluent in the presence of an auxiliary base to scavenge the hydrogen halide formed during the reaction. Suitable solvents are ethers such as diethyl ether, diisopropyl ether, tert-butyl methyl ether, dioxane, anisole and THF, nitriles such as acetonitrile and propionitrile, and dimethyl sulfoxide, dimethylformamide and dimethylacetamide, especially preferably diethyl ether and tetrahydrofuran. Mixtures of these may also be used.

Bases which are generally suitable are inorganic compounds such as alkali metal carbonates and alkaline earth metal carbonates such as lithium carbonate, potassium carbonate and calcium carbonate, and alkali metal hydrogen carbonates such as sodium hydrogen carbonate, furthermore organic bases, for example tertiary amines such as trimethylamine, triethylamine, triisopropylethylamine and N-methylpiperidine, pyridine, substituted pyridines such as collidine, lutidine and 4-dimethylaminopyridine, and bicyclic amines such as DBN or DBU. Triethylamine and pyridine are especially preferred.

In general, the bases are employed in catalytic amounts, but they may also be used in equimolar amounts, in excess or, if appropriate, as solvents.

In general, the starting materials are reacted with each other in equimolar amounts. It may be advantageous for the yields to employ VI in an excess based on V.

As an alternative, phenethylacrylamides of the formula I (and, likewise, phenethylamides of the formula I′) can be prepared in accordance with the sequence shown in scheme 2 by reacting acrylic acid compounds VII with phenethylamines VI.

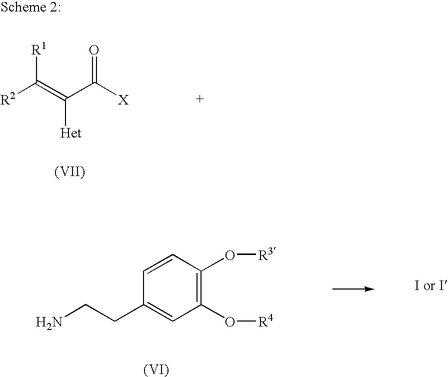

In scheme 2, R¹, R² and R⁴ have the abovementioned meanings. R³′ has the meanings mentioned for R³ and can also be an OH protecting group or hydrogen. X is preferably OH or halogen, in particular chlorine. The reaction described in scheme 2 can be carried out analogously to the reaction described in WO 91/95721 for 2-phenylacrylic compounds. As regards the reaction of the acrylic acid compound VII with the phenethylamine VI, what has been said for the amidation of the propiolic acid compounds V with the phenylamines VI also applies here.

Acrylic acid compounds of the formula VII are known per se or can be prepared by customary methods, in particular by Wittig olefination of α-ketoesters VIII. Thus, compounds VII in which R¹ and R² are identical and are Cl, F and CH₃ can be synthesized, for example, starting from α-ketoesters of the formula VIII in which R is C₁-C₄-alkyl, proceeding as described hereinbelow. The methods required for this purpose are analogous to the methods described in WO 91/95721 for the conversion of phenyl-substituted α-ketoesters into 2-arylacrylic acid compounds, so that reference is made to this publication with regard to further details.

Acrylic acid compounds VII in which R¹ and R² are chlorine can be prepared for example by reacting α-ketoesters of the formula VIII with triphenylphosphine (PPh₃) and CCl₄ to give acrylic esters of the formula VIIa (see also scheme 3). This reaction is usually carried out at temperatures of from 10° C. to 120° C., preferably from 20° C. to 80° C., in an inert organic solvent [cf. Tetrahedron Lett., p. 3003 et seq., 1988; see also WO 91/95721].

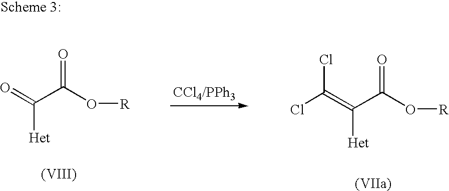

Suitable solvents are aromatic hydrocarbons such as toluene, o-, m- and p-xylene, ethers such as diethyl ether, diisopropyl ether, tert-butyl methyl ether, dioxane, anisole, tetrahydrofuran (THF), ethylene glycol dimethyl ether, diethylene glycol dimethyl ether and 1,2-diethoxyethane, nitriles such as acetonitrile and propionitrile, and also dimethyl sulfoxide, dimethylformamide and dimethylacetamide, especially preferably THF and diethylene glycol dimethyl ether. Mixtures of these may also be used.

In general, the starting materials are reacted with each other in equimolar amounts. It may be advantageous for the yield to employ CCl₄ and PPh₃ in an excess based on the α-ketoester VIII.

Compounds in which R¹ and R² are fluorine can be prepared for example by reacting α-ketoesters of the formula VIII with diphenyl-1,1-difluoromethylphoshine of the formula IX in which Ph is phenyl to give acrylic esters of the formula VIIb (see scheme 4). This reaction is usually carried out at temperatures of from −70° C. to +80° C., preferably 0° C. to 20° C., in an inert organic solvent in the presence of a base [cf. Tetrahedron Lett., p. 5571 et seq., 1990, see also WO 91/95721].

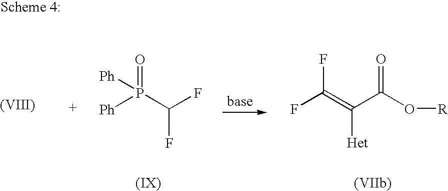

As an alternative, compounds in which R¹ and R² are fluorine can also be obtained by reacting α-ketoesters of the formula VIII with sodium-2-chloro-2,2-difluoracetate, of the formula X, and triphenylphosphine (PPh₃) to give acrylic esters of the formula VIIb (see scheme 5). This reaction is usually carried out at temperatures of from 20° C. to 180° C., preferably from 60° C. to 180° C., in an inert organic solvent [cf. Org. Synth. Vol. V, p. 949 et seq. (1973), see also WO 91/95721-A2].

Suitable solvents are ethers such as diethyl ether, diisopropyl ether, tert-butyl methyl ether, dioxane, anisole and tetrahydrofuran, especially preferably diethyl ether and tetrahydrofuran. Mixtures of these may also be used.

Suitable bases are, generally, inorganic compounds such as alkali metal hydride and alkaline earth metal hydride, such as lithium hydride, sodium hydride, potassium hydride and calcium hydride, alkali metal amides such as lithium amide, sodium amide and potassium amide, organometal compounds, in particular alkali metal alkyls such as methyllithium, butyllithium, lithiumdiisopropylamine (LDA) and phenyllithium. Butyllithium and LDA are particularly preferred.

In general, the bases are employed in catalytic amounts, but they may also be used in equimolar amounts, in excess or, if appropriate, as the solvent.

In general, the starting materials are reacted with each other in equimolar amounts. It may be advantageous for the yield to employ IX in an excess based on VIII.

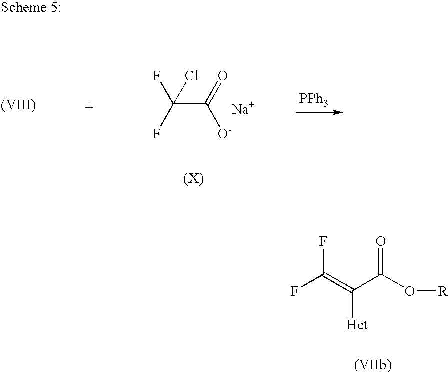

Examples of suitable solvents are aromatic hydrocarbons such as toluene, o-, m- and p-xylene, ethers such as diethyl ether, diisopropyl ether, tert-butyl methyl ether, dioxane, anisole, tetrahydrofuran (THF), ethylene glycol dimethyl ether, diethylene glycol dimethyl ether and 1,2-diethoxyethane, nitriles such as acetonitrile and propionitrile, and dimethyl sulfoxide, dimethylformamide and dimethylacetamide, especially preferably THF and diethylene glycol dimethyl ether. Mixtures of these may also be used.

In general, the starting materials are reacted with each other in equimolar amounts. It may be advantageous for the yield to employ X in an excess based on VIII.

Compounds in which R¹ and R² are methyl can be prepared for example by reacting α-ketoesters of the formula VIII with an isopropylphosphonium halide of the formula XI following the principles of a Wittig reaction (see scheme 6). Preferred among the phosphonium halides of the formula XI are the iodides and the bromides.

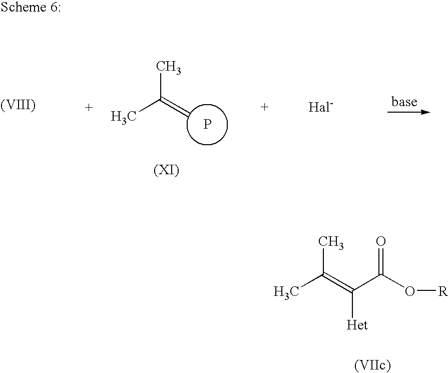

In the above reaction scheme, \mathring{P} in the formula XI is a phosphoranyl radical such as, for example, triphenylphosphoranyl.

The Wittig reaction is usually carried out at temperatures of from −78° C. to +85° C., preferably −10° C. to +65° C., in an inert organic solvent in the presence of a base [cf. Can. J. Chem. 1971, p. 2143 et seq.].

Suitable solvents are aromatic hydrocarbons such as toluene, o-, m- and p-xylene, ethers such as diethyl ether, diisopropyl ether, tert-butyl methyl ether, dioxane, anisole and tetrahydrofuran (THF), and dimethylformamide and dimethylacetamide, especially preferably diethyl ether and THF. Mixtures of these may also be used.

Bases which are generally suitable are inorganic compounds such as alkali metal hydrides and alkaline earth metal hydrides such as lithium hydride, sodium hydride, potassium hydride and calcium hydride, alkali metal amides such as lithium amide, sodium amide and potassium amide, organometal compounds, in particular alkali metal alkyls such as methyllithium, butyllithium and phenyllithium, alkali metal alkoxides and alkaline earth metal alkoxides such as sodium methoxide, sodium ethoxide, potassium ethoxide, potassium tert-butoxide and dimethoxy magnesium. Sodium hydride and sodium ethoxide are particularly preferred.

In general, the bases are employed in catalytic amounts, but they may also be used in equimolar amounts, in excess or, if appropriate, as the solvent.

In general, the starting materials are reacted with each other in equimolar amounts. It may be advantageous for the yield to employ the phosphonium halide XI in an excess based on α-ketoester VIII.

Carboxylic esters of the formula VIIa to VIIc {where X═C₁-C₄-alkoxy} in which R¹ and R² are identical and are Cl, F and CH₃ can be amidated as such by reaction with the phenethylamine VI. However, they are preferably hydrolyzed by customary methods to give the carboxylic acids of the formula VII {X═OH} [cf. Organikum, 16th Ed., pp. 415 and 622, VEB Deutscher Verlag der Wissenschaften, Berlin 1985]. The hydrolysis is usually carried out at temperatures of from 10° C. to 80° C., preferably 20° C. to 60° C., in an inert organic solvent in the presence of a base such as alkali metal hydroxides or alkaline earth metal hydroxides, in particular sodium hydroxide or potassium hydroxide.

Carboxylic acids of the formula VII can be amidated directly with phenethylamines of the formula VI in the above-described manner to give the compounds of the formula I [cf. Houben-Weyl, Methoden der Organischen Chemie, Vol. E5, p. 941-972, Georg Thieme Verlag Stuttgart and New York 1985] or via their acid chlorides.

The α-ketoesters VIII which are employed as starting materials are described in the literature in some cases or can be prepared in the manner shown in scheme 7 starting from heterocyclyl acetic esters of the formula XII (see WO 01/95721-A2).

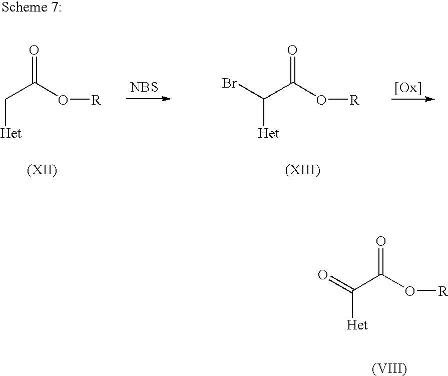

In scheme 7, Het and R have the abovementioned meanings.

The bromination of XII to the α-bromoacetic ester XIII is successfully carried out for example using N-bromosuccinimide (NBS) or 1,3-dibromo-5,5-dimethylhydantoin. The bromination is usually carried out at temperatures of from 0° C. to 200° C., preferably 20° C. to 110° C., in an inert organic solvent in the presence of a free-radical initiator [cf. Synthetic R^{e} agents, Vol. 2, pp. 1-63, Verlag Wiley, New York (1974); J. Heterocyclic Chem. pp. 1431-1436 (1993); Synth. Commun. p. 2803 et seq. (1996); J. Med. Chem. p. 481 et seq. (1981)].

The bromine compounds XIII are subsequently oxidized to give α-ketoesters VIII. The oxidation is successfully carried out with N-methylmorpholine oxide or p-dimethylaminopyridine oxide and is usually carried out at temperatures of from 0° C. to 100° C., preferably 20° C. to 60° C., in dimethyl sulfoxide [cf. Bull. Chem. Soc. Jpn., p. 2221 (1981)].

As an alternative, phenylacetic acid esters XII can also be oxidized directly to give α-ketoesters VIII. The oxidation can be carried out for example with SeO₂ or KMnO₄; it is usually carried out at temperatures of from 20° C. to 180° C., preferably 20° C. to 120° C., in an inert organic solvent [cf. Synthesis, p. 915 (1994; Synth Commun., p. 1253 (1988); J. Gen. Chem. USSR, Vol. 21, p. 694 et seq. (1951)].

The hetarylacetic esters XII which are required for the preparation of the compounds VIII are known from the literature or can be prepared in the manner shown in scheme 8.

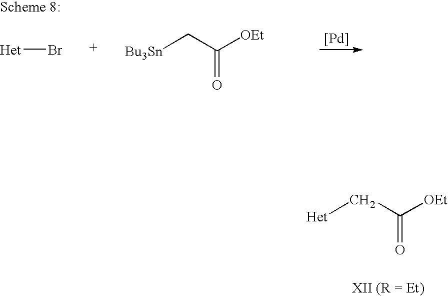

Coupling of the heteroaromatic bromides with the trialkylstannanylacetic ester(alkyl preferably n-butyl) is carried out in the manner known per se (for example analogously to Bull. Chem. Soc. Jpn. 58, 3383-84 (1985)) under the conditions of a Stille coupling (see also what has been said for the coupling of III with Het-Hal). To this end, a compound Het-Hal, preferably a compound Het-Br, is reacted with a trialkylstannanylacetic ester in the presence of catalytically active amounts of a Pd catalyst, for example of a palladium[tetrakis(triaryl)phosphine] such as Pd(PPh₃]₄ or a palladium(II) compound such as PdCl₂[P(o-tolyl)₃]₂, PdCl₂[P(phenyl)₃]₂ or PdCl₂[Ph-CN]₂. The amounts required for effective catalysis are usually in the range of from 0.5 to 10 mol %, preferably 1 to 5 mol %, based on the compound which is present in a substoichiomeric amount, for example the organotin compound III. The addition of catalytic amounts of Cu(I) salts such as Cu(I)I in an amount of from 0.5 to 10 mol %, preferably 1 to 5 mol %, based on the compound which is present in a substoichiometric amount, for example the organotin compound III, is advantageous.

The molar ratio of trialkylstannanylacetic ester to Het-Hal is preferably in the range of from 1:0.95 to 1:1.2 and especially preferably in the range of from 1:0.99 to 1:1.1.

The reaction is usually carried out in a solvent, preferably in an aprotic polar solvent such as dimethylformamide, dimethyl sulfoxide, N-methylpyrrolidone or tetrahydrofuran.

The temperatures required for the reaction are in the range of from 20 to 150° C. The tributylstannanylacetic esters are successfully prepared by the method described in zh. Obsch. Khim. 31, 2026 (1961).

If individual compounds I cannot be obtained via the above-described routes, they can be prepared by derivatizing other compounds I.

If the synthesis yields isomer mixtures, separation of the isomers is, however, generally not absolutely necessary since some of the individual isomers can undergo conversion into each other during formulation for use, or upon use (e.g. when exposed to light, acids or bases). Corresponding conversions can also take place after use, for example in the case of treatment of plants in the treated plant or in the harmful fungus or animal pest to be controlled.

The reaction mixtures are worked up in the customary manner, for example by mixing with water, separating the phases and, if appropriate, purifying the crude products by chromatography. Some of the intermediates and end products are obtained in the form of colorless or pale brown viscous oils which are freed or purified from volatile components under reduced pressure and at moderately elevated temperature. If the intermediates and end products are obtained as solids, they may also be purified by recrystallization or digestion.

The compounds I are suitable as fungicides. They are distinguished by an outstanding activity against a broad spectrum of phytopathogenic fungi, in particular from the classes of the Ascomycetes, Deuteromycetes, Phycomycetes and Basidiomycetes. Some of them act systemically, and they can be employed in crop protection as foliar- and soil-acting fungicides.

They are especially important for controlling a large number of fungi on a variety of crop plants such as wheat, rye, barley, oats, rice, maize, grass, bananas, cotton, soya, coffee, sugar cane, grapevines, fruit species, ornamentals and vegetables such as cucumbers, beans, tomatoes, potatoes and cucurbits, and on the seeds of these plants.

Specifically, they are suitable for controlling the following plant diseases:
Alternaria species on vegetables and fruit,
Botrytis cinerea (gray mold) on strawberries, vegetables, ornamentals and grapevines,
Cercospora arachidicola on peanuts,
Erysiphe cichoracearum and Sphaerotheca fuliginea on cucurbits,
Erysiphe graminis (powdery mildew) on cereals,
Fusarium and Verticillium species on various plants,
Helminthosporium species on cereals,
Mycosphaerella species on bananas and peanuts,
Phytophthora infestans on potatoes and tomatoes,
Plasmopara viticola on grapevines,
Podosphaera leucotricha on apples,
Pseudocercosporella herpotrichoides on wheat and barley,
Pseudoperonospora species on hops and cucumbers,
Puccinia species on cereals,
Pyricularia oryzae on rice,
Rhizoctonia species on cotton, rice and turf,
Septoria nodorum on wheat,
Uncinula necator on grapevines,
Ustilago species on cereals and sugar cane, and
Venturia species (scab) on apples and pears.

Moreover, the compounds I are suitable for controlling harmful fungi such as Paecilomyces variotii in the protection of materials (eg. wood, paper, paint dispersions, fibers and fabrics) and in the protection of stored products.

The compounds I are applied by treating the fungi, or the plants, seeds, materials or the soil to be protected against fungal infection, with a fungicidally active amount of the active ingredients. Application can be effected both before and after infection of the materials, plants or seeds by the fungi.

In general, the fungicidal compositions comprise from 0.1 to 95, preferably 0.5 to 90% by weight of active ingredient.

When used in crop protection, the rates of application are from 0.01 to 2.0 kg of active ingredient per ha, depending on the nature of the desired effect.

In the treatment of seed, amounts of active ingredient of from 0.001 to 0.1 g, preferably 0.01 to 0.05 g, are generally required per kilogram of seed.

When used in the protection of materials or stored products, the rate of application of active ingredient depends on the nature of the field of application and on the desired effect. Rates of application conventionally used in the protection of materials are, for example, from 0.001 g to 2 kg, preferably 0.005 g to 1 kg, of active ingredient per cubic meter of material treated.

The compounds I can be converted into the customary formulations, eg. solutions, emulsions, suspensions, dusts, powders, pastes and granules. The use form depends on the particular purpose; it is intended to ensure in each case a fine and uniform distribution of the compound according to the invention.

The formulations are prepared in a known manner, eg. by extending the active ingredient with solvents and/or carriers, if desired using emulsifiers and dispersants, it also being possible to use other organic solvents as auxiliary solvents if water is used as the diluent. Auxiliaries which are suitable are essentially: solvents such as aromatics (eg. xylene), chlorinated aromatics (eg. chlorobenzenes), paraffins (eg. mineral oil fractions), alcohols (eg. methanol, butanol), ketones (eg. cyclohexanone), amines (eg. ethanolamine, dimethylformamide) and water; carriers such as ground natural minerals (eg. kaolins, clays, talc, chalk) and ground synthetic minerals (eg. highly disperse silica, silicates); emulsifiers such as nonionic and anionic emulsifiers (eg. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates and fatty acids and their alkali metal and alkaline earth metal salts, salts of sulfated fatty alcohol glycol ether, condensates of sulfonated naphthalene and naphthalene derivatives with formaldehyde, condensates of naphthalene or of napthalenesulfonic acid with phenol or formaldehyde, polyoxyethylene octylphenyl ether, ethoxylated isooctylphenol, octylphenol, nonylphenol, alkylphenyl polyglycol ethers, tributylphenyl polyglycol ether, alkylaryl polyether alcohols, isotridecyl alcohol, fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, eg. benzene, toluene, xylene, paraffin, tetrahydronaphthalene, alkylated naphthalenes or their derivatives, methanol, ethanol, propanol, butanol, chloroform, carbon tetrachloride, cyclohexanol, cyclohexanone, chlorobenzene, isophorone, strongly polar solvents, eg. dimethylformamide, dimethyl sulfoxide, N-methylpyrrolidone and water.

Powders, materials for spreading and dusts can be prepared by mixing or concomitantly grinding the active substances with a solid carrier.

Granules, eg. coated granules, impregnated granules and homogeneous granules, can be prepared by binding the active ingredients to solid carriers. Examples of solid carriers are mineral earths, such as silicas, silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, eg. ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active ingredient. The active ingredients are employed in a purity of from 90% to 100%, preferably 95% to 100% (according to NMR spectrum).

The following are examples of formulations:
I. 5 parts by weight of a compound according to the invention are mixed intimately with 95 parts by weight of finely divided kaolin. This gives a dust which comprises 5% by weight of the active ingredient.
II. 30 parts by weight of a compound according to the invention are mixed intimately with a mixture of 92 parts by weight of pulverulent silica gel and 8 parts by weight of paraffin oil which had been sprayed onto the surface of this silica gel. This gives a formulation of the active ingredient with good adhesion properties (comprises 23% by weight of active ingredient).
III. 10 parts by weight of a compound according to the invention are dissolved in a mixture composed of 90 parts by weight of xylene, 6 parts by weight of the adduct of 8 to 10 mol of ethylene oxide and 1 mol of oleic acid N-monoethanolamide, 2 parts by weight of calcium dodecylbenzenesulfonate and 2 parts by weight of the adduct of 40 mol of ethylene oxide and 1 mol of castor oil (comprises 9% by weight of active ingredient).
IV. 20 parts by weight of a compound according to the invention are dissolved in a mixture composed of 60 parts by weight of cyclohexanone, 30 parts by weight of isobutanol, 5 parts by weight of the adduct of 7 mol of ethylene oxide and 1 mol of isooctylphenol and 5 parts by weight of the adduct of 40 mol of ethylene oxide and 1 mol of castor oil (comprises 16% by weight of active ingredient).
V. 80 parts by weight of a compound according to the invention are mixed thoroughly with 3 parts by weight of sodium diisobutylnaphthalene-alpha-sulfonate, 10 parts by weight of the sodium salt of a lignosulfonic acid from a sulfite waste liquor and 7 parts by weight of pulverulent silica gel, and the mixture is ground in a hammer mill (comprises 80% by weight of active ingredient).
VI. 90 parts by weight of a compound according to the invention are mixed with 10 parts by weight of N-methyl-α-pyrrolidone, which gives a solution which is suitable for use in the form of microdrops (comprises 90% by weight of active ingredient).
VII. 20 parts by weight of a compound according to the invention are dissolved in a mixture composed of 40 parts by weight of cyclohexanone, 30 parts by weight of isobutanol, 20 parts by weight of the adduct of 7 mol of ethylene oxide and 1 mol of isooctylphenol and 10 parts by weight of the adduct of 40 mol of ethylene oxide and 1 mol of castor oil. Pouring the solution into 100,000 parts by weight of water and finely distributing it therein gives an aqueous dispersion which comprises 0.02% by weight of the active ingredient.
VIII. 20 parts by weight of a compound according to the invention are mixed thoroughly with 3 parts by weight of sodium diisobutylnaphthalene-α-sulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20,000 parts by weight of water gives a spray mixture which comprises 0.1% by weight of the active ingredient.

The active ingredients can be used as such, in the form of their formulations or the use forms prepared therefrom, eg. in the form of directly sprayable solutions, powders, suspensions or dispersions, emulsions, oil dispersions, pastes, dusts, materials for spreading, or granules, by means of spraying, atomizing, dusting, spreading or pouring. The use forms depend entirely on the intended purposes; it is intended to ensure in each case the finest possible distribution of the active ingredients according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active ingredient concentrations in the ready-to-use preparations can be varied within relatively wide ranges. In general, they are from 0.0001 to 10%, preferably from 0.01 to 1%.

The active ingredients may also be used successfully in the ultra-low-volume process (ULV), it being possible to apply formulations comprising over 95% by weight of active ingredient, or even to apply the active ingredient without additives.

Various types of oils, herbicides, fungicides, other pesticides, or bactericides may be added to the active ingredients, if appropriate just immediately prior to use (tank mix). These agents can be admixed with the agents according to the invention in a weight ratio of 1:10 to 10:1.

In the use form as fungicides, the compositions according to the invention can also be present together with other active ingredients, eg. with herbicides, insecticides, growth regulators, fungicides or else with fertilizers. Mixing the compounds I or the compositions comprising them in the use form as fungicides with other fungicides frequently results in a broader fungicidal spectrum of action.

The following list of fungicides together with which the compounds according to the invention can be used is intended to illustrate the possible combinations, but not to impose any limitation:
sulfur, dithiocarbamates and their derivatives, such as iron(III) dimethyldithiocarbamate, zinc dimethyldithiocarbamate, zinc ethylenebisdithiocarbamate, manganese ethylenebisdithiocarbamate, manganese zinc ethylenediaminebisdithiocarbamate, tetramethylthiuram disulfide, ammonia complex of zinc (N,N-ethylenebisdithiocarbamate), ammonia complex of zinc (N,N′-propylenebisdithiocarbamate), zinc (N,N′-propylenebisdithiocarbamate), N,N′-polypropylenebis(thiocarbamoyl)disulfide;
nitro derivatives, such as dinitro(1-methylheptyl)phenyl crotonate, 2-sec-butyl-4,6-dinitrophenyl-3,3-dimethylacrylate, 2-sec-butyl-4,6-dinitrophenylisopropyl carbonate, diisopropyl 5-nitro-isophthalate;
heterocyclic substances, such as 2-heptadecyl-2-imidazoline acetate, 2,4-dichloro-6-(o-chloroanilino)-s-triazine, O,O-diethyl phthalimidophosphonothioate, 5-amino-1-[bis(dimethylamino)phosphinyl]-3-phenyl-1,2,4-triazole, 2,3-dicyano-1,4-dithioanthraquinone, 2-thio-1,3-dithiolo[4,5-b]quinoxaline, methyl 1-(butylcarbamoyl)-2-benzimidazolecarbamate, 2-methoxycarbonylaminobenzimidazole, 2-(2-furyl)benzimidazole, 2-(4-thiazolyl)benzimidazole, N-(1,1,2,2-tetrachloroethylthio)tetrahydrophthalimide, N-tri-chloromethylthiotetrahydrophthalimide, N-trichloromethylthiophthalimide,
N-dichlorofluoromethylthio-N′,N′-dimethyl-N-phenylsulfodiamide, 5-ethoxy-3-trichloromethyl-1,2,3-thiadiazole, 2-thiocyanatomethylthiobenzothiazole, 1,4-dichloro-2,5-dimethoxybenzene, 4-(2-chlorophenylhydrazono)-3-methyl-5-isoxazolone, pyridine-2-thiol 1-oxide, 8-hydroxyquinoline or its copper salt, 2,3-dihydro-5-carboxanilido-6-methyl-1,4-oxathiine, 2,3-dihydro-5-carboxanilido-6-methyl-1,4-oxathiine 4,4-dioxide, 2-methyl-5,6-dihydro-4H-pyran-3-carboxanilide, 2-methylfuran-3-carboxanilide, 2,5-dimethylfuran-3-carboxanilide, 2,4,5-trimethylfuran-3-carboxanilide, N-cyclohexyl-2,5-dimethylfuran-3-carboxamide(s), N-cyclohexyl-N-methoxy-2,5-dimethylfuran-3-carboxamide, 2-methylbenzanilide, 2-iodobenzanilide, N-formyl-N-morpholine-2,2,2-trichloroethyl acetal, piperazine-1,4-diylbis-1-(2,2,2-trichloroethyl)formamide, 1-(3,4-dichloroanilino)-1-formylamino-2,2,2-trichloroethane, 2,6-dimethyl-N-tridecylmorpholine or its salts, 2,6-dimethyl-N-cyclododecylmorpholine or its salts, N-[3-(p-tert-butylphenyl)-2-methylpropyl]-cis-2,6-dimethylmorpholine, N-[3-(p-tert-butylphenyl)-2-methylpropyl]piperidine, 1-[2-(2,4-dichlorophenyl)-4-ethyl-1,3-dioxolan-2-yl-ethyl]-1H-1,2,4-triazole, 1-[2-(2,4-dichlorophenyl)-4-n-propyl-1,3-dioxolan-2-yl-ethyl]-1H-1,2,4-triazole, N-(n-propyl)-N-(2,4,6-trichlorophenoxyethyl)-N′-imidazolylurea, 1-(4-chlorophenoxy)-3,3-dimethyl-1-(1H-1,2,4-triazol-1-yl)-2-butanone, 1-(4-chlorophenoxy)-3,3-dimethyl-1-(1H-1,2,4-triazol-1-yl)-2-butanol, (2RS,3RS)-1-[3-(2-chlorophenyl)-2-(4-fluorophenyl)oxiran-2-ylmethyl]-1H-1,2,4-triazole, α-(2-chlorophenyl)-α-(4-chlorophenyl)-5-pyrimidinemethanol, 5-butyl-2-dimethylamino-4-hydroxy-6-methylpyrimidine, bis(p-chlorophenyl)-3-pyridinemethanol, 1,2-bis(3-ethoxycarbonyl-2-thioureido)benzene, 1,2-bis(3-methoxycarbonyl-2-thioureido)benzene,
strobilurins such as methyl E-methoxyimino-[α-(o-tolyloxy)-o-tolyl]acetate, methyl E-2-{2-[6-(2-cyanophenoxy)pyrimidin-4-yloxy]-phenyl}-3-methoxyacrylate, N-methyl-E-methoxy-imino-[α-(2-phenoxyphenyl)]acetamide, N-methyl E-methoxyimino-[α-(2,5-dimethylphenoxy)-o-tolyl]acetamide,
anilinopyrimidines such as N-(4,6-dimethylpyrimidin-2-yl)aniline, N-[4-methyl-6-(1-propynyl)pyrimidin-2-yl]aniline, N-[4-methyl-6-cyclopropylpyrimidin-2-yl]aniline,
phenylpyrroles such as 4-(2,2-difluoro-1,3-benzodioxol-4-yl)pyrrole-3-carbonitrile,
cinnamamides such as 3-(4-chlorophenyl)-3-(3,4-dimethoxy-phenyl)acryloylmorpholine,
and a variety of fungicides such as dodecylguanidine acetate, 3-[3-(3,5-dimethyl-2-oxycyclohexyl)-2-hydroxyethyl]glutarimide, hexachlorobenzene, methyl N-(2,6-dimethylphenyl)-N-(2-furoyl)-DL-alaninate, DL-N-(2,6-dimethylphenyl)-N-(2′-methoxyacetyl)-alanine methyl ester, N-(2,6-dimethylphenyl)-N-chloroacetyl-D,L-2-amino-butyrolactone, DL-N-(2,6-dimethylphenyl)-N-(phenylacetyl)-alanine methyl ester, 5-methyl-5-vinyl-3-(3,5-dichlorophenyl)-2,4-dioxo-1,3-oxazolidine, 3-(3,5-dichlorophenyl)5-methyl-5-methoxymethyl-1,3-oxazolidine-2,4-dione, 3-(3,5-dichlorophenyl)-1-isopropylcarbamoylhydantoin, N-(3,5-dichlorophenyl)-1,2-dimethylcyclopropane-1,2-dicarboximide, 2-cyano-[N-(ethylaminocarbonyl)-2-methoximino]acetamide, 1-[2-(2,4-dichlorophenyl)pentyl]-1H-1,2,4-triazole, 2,4-difluoro-α-(1H-1,2,4-triazolyl-1-methyl)benzhydryl alcohol, N-(3-chloro-2,6-dinitro-4-trifluoromethylphenyl)-5-trifluoromethyl-3-chloro-2-aminopyridine, 1-((bis(4-fluorophenyl)methylsilyl)methyl)-1H-1,2,4-triazole.

### PREPARATION EXAMPLES

With due modification of the starting compounds, the procedures given in the synthesis examples hereinbelow were used to obtain further compounds I. The resulting compounds, together with physical data, are listed in the subsequent table.

### Example 1

### (2Z)-N-[2-(3,4-Dimethoxyphenyl)ethyl]-4-methyl-2-[5-(trifluoromethyl)-2-pyridinyl]-2-pentenamide

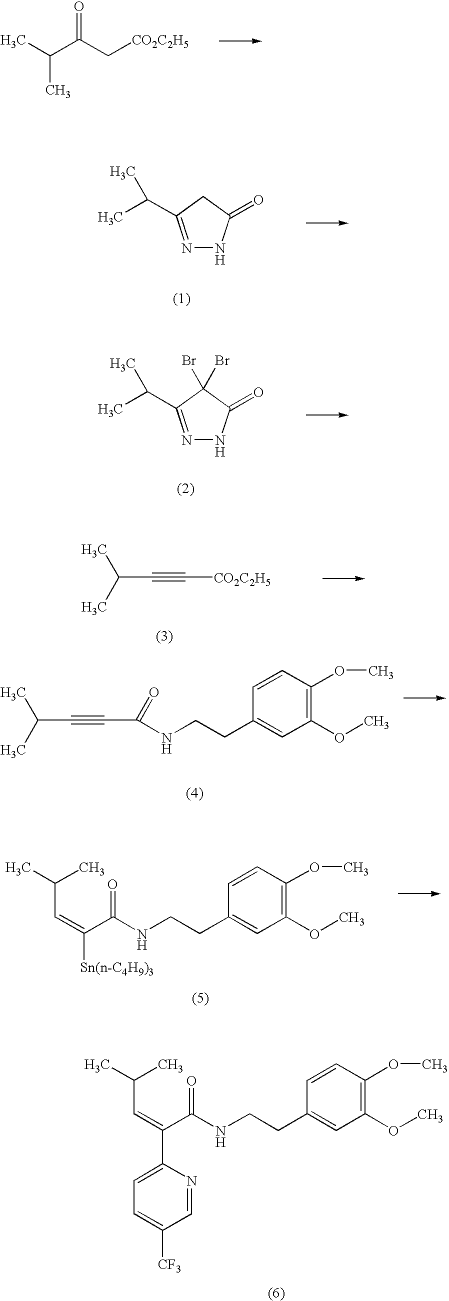

### 1.1 5-Isopropyl-2,4-dihydro-3H-pyrazol-3-one (1)

70 g (1.26 mol) of hydrazine hydrate were added dropwise at 10-30° C. to 100 g (0.62 mol) of ethyl 2-isobutyrylacetate (=4-methyl-3-oxopentanoic acid ethyl ester) in 60 ml of ethanol. After the exothermic reaction had subsided, the mixture was stirred over 16 hours and cooled to −10° C., and the title compound 1 was filtered off with suction. Yield: 52 g.

¹H NMR (CDCl₃): δ 9.5 (br, 1H); 5.25 (s, 1H); 2.75 (q, 1H); 1.1 (d, 6H).

### 1.2 4,4-Dibromo-5-isopropyl-2,4-dihydro-3H-pyrazol-3-one (2)

140 g (0.87 mol) of bromine were added dropwise to 52 g (0.41 mol) of 5-isopropyl-2,4-dihydro-3H-pyrazol-3-one (1) in 300 ml of glacial acetic acid. The reaction mixture was subsequently poured into ice-water and the title compound 2 which had precipitated was filtered off with suction. Yield: 113 g

¹H NMR (CDCl₃): δ 9.5 (br, 1H); 3.0 (q, 1H); 1.35 (d, 6H).

### 1.3 4-Methyl-2-pentynoic acid (3)

60 g (0.21 mol) of 4,4-dibromo-5-isopropyl-2,4-dihydro-3H-pyrazol-3-one (2) in 150 ml methyl tert-butyl ether were added dropwise at 0° C. to 400 ml of 10% strength sodium hydroxide solution and the mixture was stirred for 3 hours at room temperature. The aqueous phase was separated off, brought to pH 2.5 with concentrated hydrochloric acid and extracted with methyl tert-butyl ether, and the extract was dried. After removal of the solvent, 23.3 g of 4-methyl-2-pentynoic acid (3) were obtained.

¹H NMR (CDCl₃): δ 8.0 (br, OH); 2.7 (q, 1H); 1.2 (d, 6H).

### 1.4 2-(3,4-Dimethoxyphenyl)ethyl-4-methyl-2-pentynoate (4)

At 0-5° C., 38.2 g (280 mmol) of isobutyl chloroformate and, at 5-15° C., 28.3 g (280 mmol) of N-methylmorpholine were added dropwise to 28.4 g (254 mmol) of 4-methyl-2-pentynoic acid (3) in 100 ml of THF. 46 g (254 mmol) of homoveratrylamine were subsequently added dropwise with ice-cooling, and stirring was continued for 48 hours at room temperature. Thereupon, the reaction mixture was concentrated, the residue was poured into water/10% strength hydrochloric acid, and the aqueous mixture was extracted with methyl tert-butyl ether. After drying and concentration, the residue was chromatographed over silica gel using cyclohexane/methyl tert-butyl ether (3:1), yielding 44 g of compound 4.

¹H NMR (CDCl₃): δ 6.85-6.6 (m, 3H); 5.75 (m, 1H); 3.85 (s, 3H); 3.80 (s, 3H), 3.5 (q, 2H).

### 1.5 (2E)-N-[2-(3,4-Dimethoxyphenyl)ethyl]-4-methyl-2-(tributylstannyl)-2-pentenamide (5)

0.8 g of Pd(PPh₃)₄ was added to 47.1 g (170 mmol) of 2-(3,4-dimethoxyphenyl)ethyl-4-methyl-2-pentynoate (4) in 200 ml of THF, and 51 g (175 mmol) of tributyltin hydride in 50 ml of tetrahydrofuran were added dropwise at 15-20° C. Stirring was continued for 16 hours at room temperature, the mixture was concentrated, and the residue was chromatographed over silica gel using cyclohexane/methyl tert-butyl ether (3:1). This gave 88.8 g of compound 5 as a viscous oil.

¹H NMR (CDCl₃): δ 6.8-6.7 (m, 3H); 5.4 (d, 1H); 5.2(m, 1H); 3.9 (s, 3H); 3.85 (s, 3H).

### 1.6 (2Z)-N-[2-(3,4-Dimethoxyphenyl)ethyl]-4-methyl-2-[5-(trifluoromethyl)-2-pyridinyl]-2-pentenamide (6)

0.5 g (2.21 mmol) of 2-bromo-5-trifluoromethylpyridine, 140 mg Pd(PPh₃)₄ and approx. 100 mg of copper(I) iodide were added to 1.28g (2.21 mmol) of (2E)-N-[2-(3,4-dimethoxyphenyl)ethyl]-4-methyl-2-(tributylstannyl)-2-pentenamide (5) in 2 ml of dimethylformamide. The mixture was stirred overnight at room temperature, poured into water and extracted with methyl tert-butyl ether. The organic phases were washed with water, dried and concentrated. The residue was chromatographed over silica gel using cyclohexane/methyl tert-butyl ether (3:1 to 1:1), yielding 0.5 g of the final product 6.

¹H NMR (CDCl₃): δ 8.75 (s, 1H); 7.8 (d, 1H); 7.35 (d, 1H); 4.0 (q, 2H); 3.8 (s, 3H).

The compounds of Examples 2 to 23 were prepared analogously. The compound of Example 2 was obtained as by-product in the preparation of Example 3. The physical data of the compounds of Examples 1 to 23 are shown in Table B. As regards the ¹H NMR spectra, only characteristic signals were stated. All of the chemical shifts are based on tetramethylsilane. s represents singlet, q quartet, t triplet and m higher-order multiplet.

TABLE B

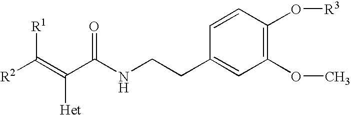

| | | | | | Physical |
|---|---|---|---|---|---|
| | | | | | data (m.p. |
| | | | | | [° C.]; ¹H NMRδ |
| Ex. | R¹ | R² | Het | R³ | [ppm], GC[min]) |
| 1 | CH(CH₃)₂ | H | 5-CF₃-pyri- | CH₃ | 8.75(s, 1H); |
| | | | din-2-yl | | 7.8(d, 1H); |
| | | | | | 7.35(d, 1H); |
| | | | | | 4.0(q, 2H); |
| | | | | | 3.8(s, 3H) |
| 2 | H | C₂H₅ | pyridin-2-yl | C₂H₅ | 1.1(t, 3H); 1.4(t, |
| | | | | | 3H); 2.75(t, |
| | | | | | 2H); 3.2(q, 2H); |
| | | | | | 3.6(q, 2H); 3.8(s, |
| | | | | | 3H); 4.0(q, |
| | | | | | 2H) |
| 3 | C₂H₅ | H | 5-methyl-py- | C₂H₅ | 49-56 |
| | | | ridin-2-yl | | |
| 4 | C₂H₅ | H | pyridin-2-yl | C₂H₅ | 79-80 |
| 5 | C₂H₅ | H | 4-methyloxa- | C₂H₅ | 0.9(t, 3H); 2.3(s, |
| | | | zol-2-yl | | (s, 3H); 2.6(q, |
| | | | | | 2H); 2.8(t, 2H); |
| | | | | | 3.7(q, 2H); 3.8(s, |
| | | | | | 3H) |
| 6 | c-C₆H₁₁ | H | 5-bromopyri- | CH₃ | 8.5(s, 1H); 7.7(d, |
| | | | din-2-yl | | 1H); 7.1(d, |
| | | | | | 1H); 1.6-1.8(m, |
| | | | | | 5H); 1.05-1.4(m, |
| | | | | | 5H) |
| 7 | CH(CH₃)₂ | H | 5-CF₃-pyri- | C₂H₅ | 8.75(s, 1H); |
| | | | din-2-yl | | 7.8(d, 1H); |
| | | | | | 7.35(d, |
| | | | | | 1H); 4.0(q, 2H); |
| | | | | | 3.8(s, 3H) |
| 8 | c-₃H₅ | H | 5-bromopyri- | CH₃ | 8.4(s, 1H); 5.8(s, |
| | | | din-2-yl | | 1H); 3.9(s, |
| | | | | | 3H); 3.8(s, 3H); |
| | | | | | 2.85(t, 2H) |
| 9 | C(CH₃)₃ | H | 5-CF₃-pyri- | C₂H₅ | 1.1(s, 9H); 1.4(t, |
| | | | din-2-yl | | 3H); 2.75(t, |
| | | | | | 2H); 6.1(m, 1H); |
| | | | | | 8.75(s, 1H) |
| 10 | CH(CH₂CH₃)₂ | H | 5-CF₃-pyri- | CH₃ | 2.55(m); 2.8(d); |
| | | | din-2-yl | | 3.75(m); 3.95(d); |
| | | | | | 6.3(d); 7.35(d); |
| | | | | | 8.75(s) |
| 11 | CH(CH₂CH₃)₂ | H | 5-CH₃-pyri- | CH₃ | GC: 13.8 |
| | | | din-2-yl | | |
| 12 | C₂H₅ | H | 5-CF₃-pyri- | CH₃ | GC: 12.12 |
| | | | din-2-yl | | |
| 13 | C₂H₅ | H | 5-bromo-pyri- | C₂H₅ | GC: 13.88 |
| | | | din-2-yl | | |
| 14 | C₂H₅ | H | 5-CF₃-pyri- | C₂H₅ | GC: 12.30 |
| | | | din-2-yl | | |
| 15 | C₂H₅ | H | 5-bromo-pyri- | CH₃ | GC: 14.1 |
| | | | din-2-yl | | |
| 16 | CH(CH₃)₂ | H | 5-CF₃-pyri- | CH₃ | GC: 12.07 |
| | | | din-2-yl | | |
| 17 | CH(CH₃)₂ | H | 5-bromo-pyri- | CH₃ | GC: 13.82 |
| | | | din-2-yl | | |
| 18 | C(CH₃)₃ | H | 5-CF₃-pyri- | CH₃ | GC: 12.34 |
| | | | din-2-yl | | |
| 19 | C(CH₃)₃ | H | 5-bromo-pyri- | CH₃ | GC: 14.13 |
| | | | din-2-yl | | |
| 20 | c-C₃H₅ | H | 5-CF₃-pyri- | CH₃ | 105-108 |
| | | | din-2-yl | | |
| 21 | C(CH₃)₂OCH₃ | H | 5-bromo-pyri- | CH₃ | 3.2(s); 3.7(m); |
| | | | din-2-yl | | 3.85(s); 7.2(d); |
| | | | | | 8.6(s) |
| 22 | C(CH₃)CH₂CH₃ | H | 5-bromo-pyri- | CH₃ | 2.8(t); 3.7(m); |
| | | | din-2-yl | | 3.85(d); 6.25(d); |
| | | | | | 7.75(d); 8.5(s) |
| 23 | CH(CH₂CH₃)₂ | H | 5-bromo-pyri- | CH₃ | 2.6(m); 2.8(d); |
| | | | din-2-yl | | 3.7(m); 3.95(d); |
| | | | | | 6.2(d); 7.2(d); |
| | | | | | 7.75(t); 8.5(s) |

c = cyclo
*GC: conditions: column: 10 m; Optima 1, Macherey & Nagel; programm: 80/0/15/280/16/293

Examples of the action against harmful fungi

The fungicidal action of the compounds of the formula I is demonstrated by the following experiments:

The active ingredients were prepared separately or jointly as a 10% emulsion in a mixture of 85% by weight cyclohexanone and 5% by weight Wettol® EM (nonionic emulsifier based on ethoxylated castor oil) in the form of a stock solution and diluted with water to give the desired concentration.

### Use Example 1

### Activity Against Gray Mold on Capsicum Leaves Caused by Botrytis cinerea

Capsicum seedlings cv. “Neusiedler Ideal Elite” were allowed to develop 4-5 leaves properly and were then sprayed to runoff point with an aqueous suspension made with the above stock solution. The next day, the treated plants were inoculated with a spore suspension of Botrytis cinerea which contained 1.7×10⁶ spores/ml in a 2% strength aqueous Biomalz solution. The test plants were subsequently placed into a controlled-environment cabinet at 22-24° C. and high atmospheric humidity. After 5 days, it was possible to visually determine the extent of the fungal infection on the leaves in %.

In this study, the plants treated with 250 ppm of the respective active ingredient of Examples 2, 4 or 5 of Table B showed a disease level of not more than 5% or no disease at all, while the untreated plants showed a disease level of 90%.

### Use Example 2

### Activity Against Tomato Blight Caused by Phytophthora infestans

Leaves of potted plants cv. “GroBe Fleischtomate St. Pierre” were sprayed to runoff point with an aqueous suspension made with the above stock solution. The next day, the leaves were inoculated with a cold aqueous zoospore suspension of Phytophthora infestans at a concentration of 0.25×10⁶ spores/ml. The plants were subsequently placed into a chamber with 100% atmospheric humidity at temperatures of between 18 and 20° C. After 6 days, the blight had developed to such an extent on the untreated, but inoculated, control plants that it was possible to visually determine the disease level in %.

In this study, the plants which had been treated with 250 ppm of the respective active ingredient of Example 2 or 4 of Table B showed a disease level of not more than 15% and those which had been treated with 250 ppm of the active ingredients of Example 5, 7, 8 or 9 were disease-free, while the disease level of the untreated plants was 100%.

### Use Example 3

### Activity Against Downy Mildew of Grapevine Caused by Plasmopara viticola

Leaves of potted grapevines cv. “Müller-Thurgau” were sprayed to runoff point with an aqueous suspension prepared with the above stock solution. The next day, the undersides of the leaves were inoculated with an aqueous zoospore suspension of Plasmopara viticola. Thereafter, the grapevines were first placed for 48 hours into a chamber at 24° C. and 100% atmospheric humidity and subsequently for 5 days in a greenhouse at temperatures of between 20 and 30° C. After this time, the plants were returned for 16 hours into a humid chamber to accelerate the eruption of sporangiophores. The extent to which the disease had developed on the undersides of the leaves was then determined visually.

In this study, the plants which had been treated with 250 ppm of the respective active ingredient of Example 7, 8 or 9 of Table B showed a disease level of not more than 5% or were free from disease, while the untreated plants showed a disease level of 80%.

1. Phenethylacrylamides of the formula I 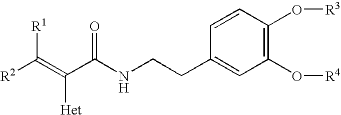
in which the substituents R¹, R², R³ and R⁴ have the following meanings:
R¹ is halogen, C₁-C₄-alkyl, C₁-C₄-alkoxy, C₃-C₁₀-cycloalkyl, C₁-C₄-haloalkoxy or C₁-C₄-haloalkyl;
R² is hydrogen;
R³ is C₁-C₄-alkyl, C₁-C₄-haloalkyl, propargyl, C₃-C₄-alkenyl or —H₂C—C≡C—C(R^{a}, R^{a})—R^{c}, where R^{a}, R^{b} independently of one another are hydrogen or methyl and R^{c} is hydrogen or C₁-C₄-alkyl;
R⁴ is methyl or C₁-haloalkyl; and
Het is a 5- or 6-membered heteroaromatic ring which may contain a fused 5- or 6-membered carbocycle and which is selected from among heteroaromatic rings containing 1, 2, 3 or 4 nitrogen atoms as ring members, heteroaromatic rings which contain 1 or 2 nitrogen atoms and 1 or 2 further heteroatoms selected from among oxygen or sulfur as ring members, and heteroaromatic rings which have 1 or 2 heteroatoms selected from among oxygen and sulfur as ring members, Het being unsubstituted or it being possible for Het to contain 1, 2 or 3 substituents S selected from among halogen, C₁-C₄-alkyl, C₁-C₄-haloalkoxy, C₁-C₄-haloalkyl and C₁-C₄-alkoxy.

2. A phenethylacrylamide of the formula I as claimed in claim 1, wherein R¹ is C₁-C₄-alkyl or C₃-C₆-cycloalkyl, in particular ethyl, isopropyl, tert-butyl or cyclopropyl.

3. A phenethylacrylamide of the formula I as claimed in any of the preceding claims, wherein Het is selected from among pyridyl, pyrimidinyl, pyrazinyl, pyrrolyl, thienyl, furanyl, pyrazolyl, imidazolyl, oxazolyl, isoxazolyl, thiazolyl and isothiazolyl.

4. A phenethylacrylamide of the formula I as claimed in any of the preceding claims, wherein Het contains one or two substituents S which are bonded to those ring atoms which are not adjacent to the linkage site forming the double bond.

5. A phenethylacrylamide of the formulae I.1, I.2 and I.3 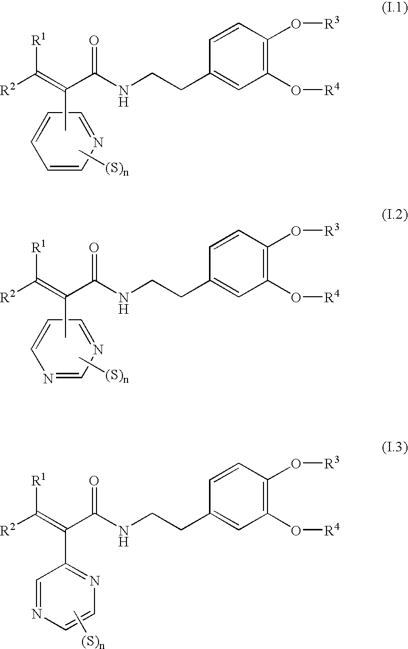
in which the substituents S, R¹, R², R³ and R⁴ have the abovementioned meanings and n is 1 or 2, and S is not bonded in the ortho position relative to the linkage site.

6. A process for the preparation of a phenethylacrylamide of the formula I as claimed in any of the preceding claims, wherein R² is hydrogen and R¹ is hydrogen, C₁-C₄-alkyl, C₃-C₈-cycloalkyl or C₁-C₄-haloalkyl, and Het, R³ and R⁴ have the abovementioned meanings, comprising the following steps:
a) reaction of a phenethylamide of the formula II, 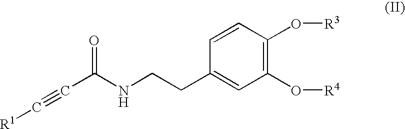
in which the substituents R¹, R³ and R⁴ have the abovementioned meanings, with a trialkylstannane (R^{a})₃SnH, wherein R^{a} is alkyl resulting in a compound of the formula III 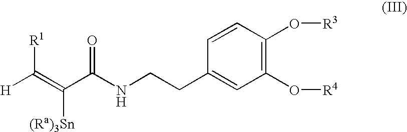
wherein the substituents R^{a}, R¹, R³ and R⁴ have the abovementioned meanings, and
b) reaction of the compound III obtained in step a) with a compound Het-Hal, wherein Hal is bromine or iodine and Het has the meaning given in claim 1, in the presence of catalytically active amounts of a transition metal compound of a group VIII metal;
or
a′) reaction of a compound of the formula II with at least stoichiometric amounts of iodine, resulting in a compound of the formula IV 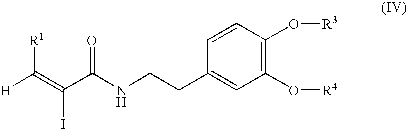
wherein the substituents R¹, R³ and R⁴ have the abovementioned meanings, and
b′) reaction of the compound IV obtained in step a′) with a stannane of the formula (R^{a})₃Sn-Het, wherein Het has the meaning stated in claim 1, in the presence of catalytically active amounts of a transition metal compound of a group VIII metal.

7. A process as claimed in claim 6, additionally comprising the preparation of the phenethylamide of the formula II, wherein a propiolic acid compound of the formula V 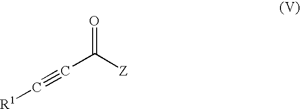
wherein R¹ has the abovementioned meaning and Z is halogen or OH, is reacted in a manner known per se with a phenethylamine of the general formula VI 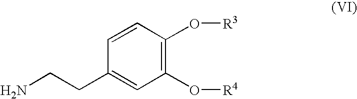
wherein R³ and R⁴ have the abovementioned meanings.

8. A process for the preparation of a phenethylacrylamide as claimed in claim 1 of the formula I, wherein a phenethylacrylamide of the formula I where R³═H: 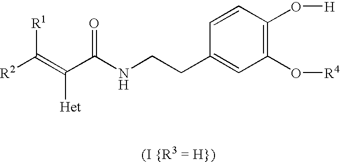
wherein Het, R¹, R² and R⁴ have the abovementioned meanings, is reacted with a compound of the formula R³—Y, wherein R³ has the abovementioned meaning and Y is a nucleophilically displaceable leaving group.

9. A phenethylamide of the formula II′ 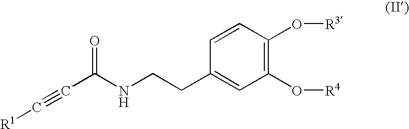
wherein the substituents R¹ and R⁴ have the abovementioned meanings, R³′ has the meanings stated for R³ or R³′ is hydrogen or an OH protecting group.

10. A phenethylacrylamide of the formula I′: 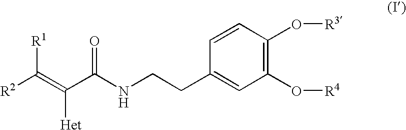
wherein Het, R¹, R² and R⁴ have the abovementioned meanings and R³′ is hydrogen or an OH protecting group.

11. A composition for controlling phytopathogenic harmful fungi comprising a solid or liquid carrier and a compound of the formula I as claimed in any of claims 1 to 5.

12. A method of controlling phytopathogenic harmful fungi, which comprises treating the fungi or the materials, plants, the soil or seed to be protected from fungal infection with an effective amount of a compound of the formula I as claimed in any of claims 1 to 5.
